(19) United States
(12) Patent Application Publication
(10) Pub. No.: US 2025/0064242 A1
(43) Pub. Date: Feb. 27, 2025

(54) STORAGE ACCESSORIES WITH AESTHETIC COVER AND REMOVABLE WALL MOUNT

(71) Applicant: 3M INNOVATIVE PROPERTIES COMPANY, St. Paul, MN (US)

(72) Inventors: Pei-Chun Chang, Taoyuan City (TW); Craig D. Thompson, Inver Grove Heights, MN (US); Judd D. Olson, Maplewood, MN (US); Andrew T. Helgeson, Maplewood, MN (US)

(21) Appl. No.: 18/841,885

(22) PCT Filed: Feb. 28, 2022
(86) PCT No.: PCT/IB2022/051735

§ 371 Date: Aug. 27, 2024

(51) Int. Cl. A47G 29/087; A47B 55/02

(52) U.S. Cl. CPC A47G 29/087; A47B 55/02; A47B 2220/0036

(57) ABSTRACT

The present disclosure provides adhesive mounting assemblies that can be removed from surfaces without damage by having reduced contribution of a hardgood to the peel force generated by the adhesive article during removal. In some instances, this can be accomplished by a mounting plate that includes one or more mounting bodies that are flexible in a peel direction and rigid in a weight hanging direction. The mounting assemblies may further include a cover to stabilize the assembly during use and obscure aspects of the mounting plate.

### TECHNICAL FIELD

The present disclosure generally relates to mountable assemblies that are capable of attaching or adhering to a substrate and that can be removed from the substrate without causing damage to the substrate. The present disclosure also generally relates to methods of making and using such assemblies.

### SUMMARY

Existing peelable adhesive products often do not work well on various surfaces, including, for example, painted surfaces and rough surfaces (e.g., drywall). Additionally, the existing peelable products can exhibit low shear strength and thus can hold little weight or alternatively require a relatively thick construction, which can cause an increase in the potential for damage when such products are removed from an adherend. Moreover, the mounting devices typically include a relatively rigid hardgood used to mount the desired object, which can increase the peel force necessary to remove the mounting device. This difficulty in removal often subjects the user to at least a multiple removal steps or requires the use of multicomponent constructions that tend to increase manufacturing complexity and cost. Attempts have been made to replace existing backings with those having lower stiffness (modulus) to reduce the peel force upon removal. Soft, elastic backings, for example, have been shown to result in lower peel forces, which correlate with appreciable stretch (strain) of the adhesive at release. Even with advantageous modifications to the backing materials, the present inventors recognized that adhesive articles remained difficult to remove in a single step and still experienced visible damage. As such, the inventors of the present disclosure sought to formulate peelable mounting products with at least one of higher shear strength, ability to work well on painted or rough surfaces, that are capable of consistently holding higher weights, and/or that are easier for the user to remove from the substrate, all without damaging the substrate to which they are applied.

The inventors of the present disclosure recognized that the existing peel release adhesive products could be improved or enhanced by reducing or eliminating the contribution of the hardgood to peel force generated by the adhesive during removal. In some instances, this can be accomplished by increasing the flexibility of the hardgood in one or more directions offset from the direction of gravitational force provided by an object to be mounted. The increased flexibility tends to reduce the peel force necessary to remove the product by easing the peel force required to separate the hardgood from the substrate; the adhesive articles of the present disclosure can accordingly capitalize on myriad adhesive constructions without deleteriously impacting damage free removability. In some instances, the enhanced construction of the hardgood allows the adhesive articles to hold more weight. In some embodiments, the enhanced performance permits the adhesive articles to be used in difficult environments (e.g., the bathroom or shower). In some embodiments, the enhanced removability increases or enhances the product performance on certain surfaces (e.g., rough or textured surfaces such as, for example, wallpaper, drywall, etc.).

The inventors of the present disclosure also recognized that providing a hardgood that has anisotropic flexibility is a novel and effective method to increase performance of the adhesive article while enhancing the damage-free features of the product.

In one aspect, the present disclosure provides an adhesive article comprising a flexible body and an adhesive disposed adjacent a rear major surface of the body. The flexible body includes a plurality of body segments, each including a linear segment and a related connector element. The body segments are spaced apart at a certain frequency and connected only at discrete locations displaced from the center of the body. The connections can be located adjacent an edge region of the body and serve to connect two adjacent segments. In some implementations, the body segments oscillate about a central axis and include linear elements arranged substantially in parallel. Such implementations may include arcuate connector elements.

The flexible body may further include a projection for mounting an object. The projection may include projection segments, spaced apart at a certain frequency and connected at an edge region.

The adhesive may be disposed directly on a major surface of the body segments. In other implementations, the flexible body may include a backplate having at least one of length and width dimensions greater than the corresponding dimensions of the body segments. The backplate may be made monolithic with the body segments or may be adhered or otherwise coupled to the body segments. The adhesive in such implementations will be disposed on a rear major surface of the backplate. Mounting assemblies according to present disclosure demonstrate at least one of damage free removal. repositionability, and high shear strength, even in wet or humid environments (e.g., the bathroom).

In one aspect of the present disclosure, a mountable apparatus comprises a storage device including at least one wire segment; at least one mounting plate onto which at least one of the wire segments is engaged; and optionally a cover attachable to the wire structure, the cover obscuring the at least one hanger and at least a portion of at least one of the wire segments.

In another aspect of the present disclosure, a mounting plate comprises a solid backplate having a longitudinal length and latitudinal width; and a plurality of fins on a first major surface of the backplate, wherein the fins extend at least a portion of the length and are spaced from one another along the width, and wherein at least some of the fins include a hook portion projecting from a front surface of the fin and defining a recess.

As used herein, “layer” means a single stratum that may be continuous or discontinuous over a surface.

As used herein, the terms, “height”, “depth”, “top” and “bottom” are for illustrative purposes only, and do not necessarily define the orientation or the relationship between the surface and the intrusive feature. Accordingly, the terms “height” and “depth”, as well as “top” and “bottom” should be considered interchangeable.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As recited herein, all numbers should be considered modified by the term “about”.

As used herein, “a”, “an”, “the”, “at least one”, and “one or more” are used interchangeably. Thus, for example, an adhesive article comprising “an” adhesive layer can be interpreted as a core comprising “one or more” adhesive layers.

Also herein, the recitations of numerical ranges by endpoints include all numbers subsumed within that range (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF DRAWINGS

FIG. 1 is a perspective view of one embodiment of an exemplary mounting assembly of the type generally described herein;

FIG. 2 is an exploded perspective view of the mounting assembly of FIG. 1;

FIG. 3 is a perspective view of the mounting plate used in the mounting assembly of FIG. 1;

FIG. 4 is a perspective view of a flexible mounting body of the mounting plate of FIG. 3;

FIG. 5 is a rear perspective view of the aesthetic cover used with the mounting assembly of FIG. 1;

FIG. 6 is a side view of the cover of FIG. 5;

FIG. 7 is a perspective view of the mounting assembly of FIG. 1 without the aesthetic cover;

FIG. 8 is a perspective view of another embodiment of a mounting plate according to the present disclosure.

FIG. 9 is a perspective view of a storage device according to an embodiment of the present disclosure;

FIG. 10 is a perspective view of a storage device according to an embodiment of the present disclosure;

FIG. 11 is a perspective view of a storage device according to an embodiment of the present disclosure;

FIG. 12 is a perspective view of a storage device according to an embodiment of the present disclosure;

FIG. 13 is a perspective view of a storage device according to an embodiment of the present disclosure;

FIG. 14 is a perspective view of a storage device according to an embodiment of the present disclosure;

FIG. 15 is a perspective view of a storage device according to an embodiment of the present disclosure;

FIG. 16 is a perspective view of a storage device according to an embodiment of the present disclosure;

FIG. 17 is a perspective view of a mounting assembly according to an embodiment of the present disclosure;

FIG. 18 is a perspective view of a mounting assembly according to an embodiment of the present disclosure;

FIG. 19 is a perspective view of a mounting assembly according to an embodiment of the present disclosure;

FIG. 20 is a perspective view of a mounting assembly according to an embodiment of the present disclosure;

FIG. 21 is a perspective view of a mounting assembly according to an embodiment of the present disclosure;

FIG. 22 is a perspective view of a mounting assembly according to an embodiment of the present disclosure;

FIG. 23 is a perspective view of a mounting assembly according to an embodiment of the present disclosure; and

FIG. 24 is a perspective view of a mounting assembly according to an embodiment of the present disclosure.

Layers in certain depicted embodiments are for illustrative purposes only and are not intended to absolutely define the thickness, relative or otherwise, or the absolute location of any component. While the above-identified figures set forth several embodiments of the disclosure other embodiments are also contemplated, as noted in the description. In all cases, this disclosure is presented by way of representation and not limitation. It should be understood that numerous other modifications and embodiments can be devised by those skilled in the art, which fall within the scope and spirit of the principles of the disclosure.

### DETAILED DESCRIPTION

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

The present disclosure generally relates to adhesive articles that can be removed from a substrate, wall, or surface (generally, an adherend) without damage to the adherend or at least some components of the article (e.g., the flexible body as described below). As used herein, the terms “without damage” and “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

The assemblies of the present disclosure include a flexible mounting body, a wireframe storage device or accessory including one or more wire segments, and one or more aesthetic covers. The flexible mounting body can include a plurality of load bearing segments and can be peelable or stretch releasable from an adherend. As used herein, the term “peelable” means that the adhesive article can be removed from a substrate or surface by peeling at angle of between about 1° and about 180°. In some embodiments, the adhesive article can be removed from a substrate or surface by peeling at angle of between 30° to 120°. In some embodiments, the adhesive article can be removed from a substrate or surface by peeling at angle of at least about 35°.

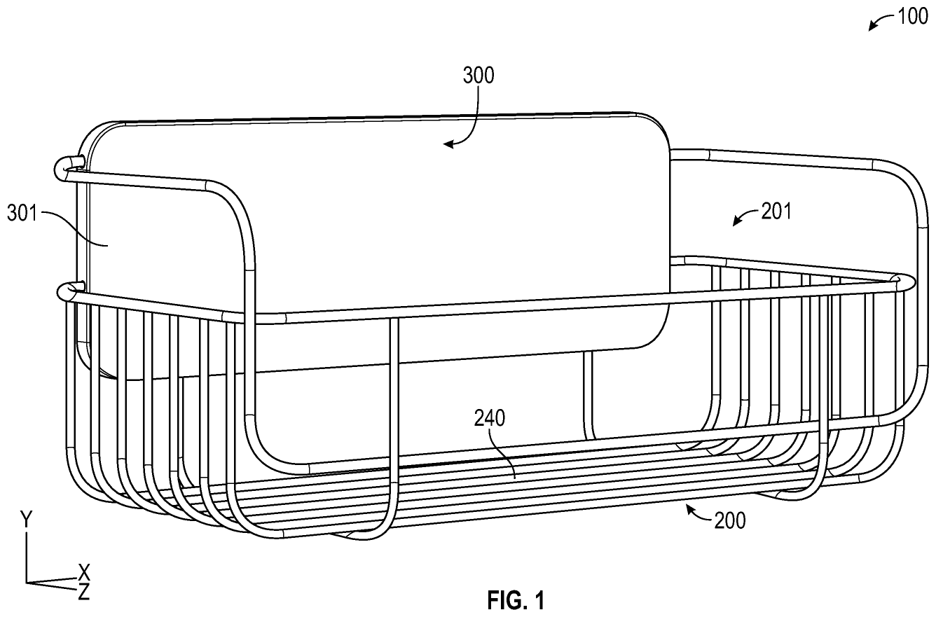

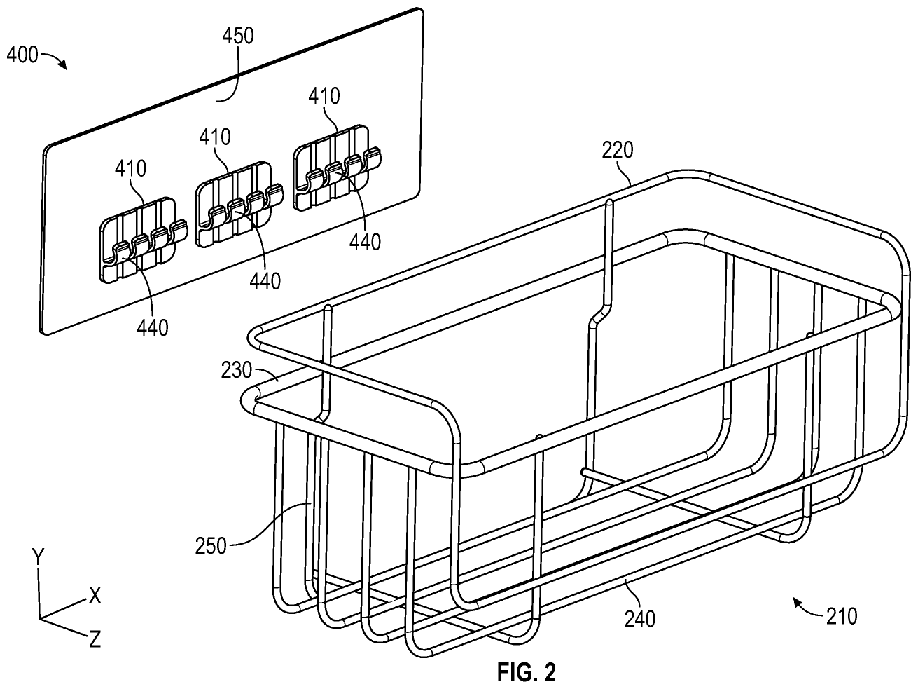

FIGS. 1 and 2 depict an exemplary embodiment of a mounting assembly 100 as generally described herein. The mounting assembly 100 includes a storage device 200 and an aesthetic cover 300. The cover 300 is positioned adjacent a posterior region 202 of the storage device 200 and provides a continuous major surface 310 that extends substantially the length 204 of the storage device 200. The cover 300 may include a single cover body 301 as depicted or may include several separate bodies each covering a discrete portion of the storage device 200. As detailed below, the cover 300 may be releasably connectable to parallel or substantially parallel components (e.g., wires) 220, 230 on the storage device 200. The cover 300 acts to at least partially obscure the mounting plate 400, which includes one or more flexible mounting bodies 410, from view.

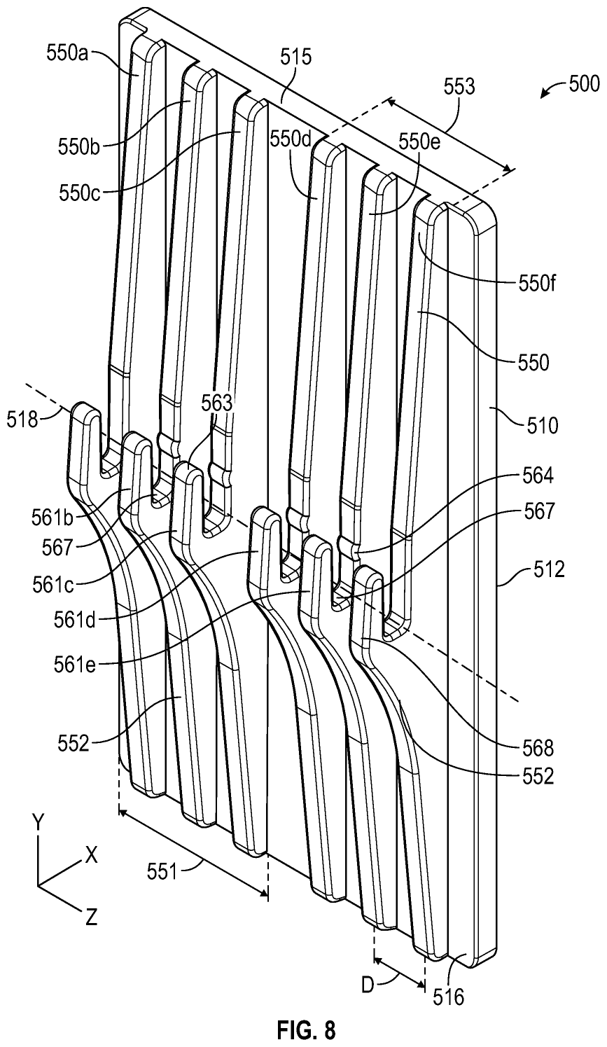

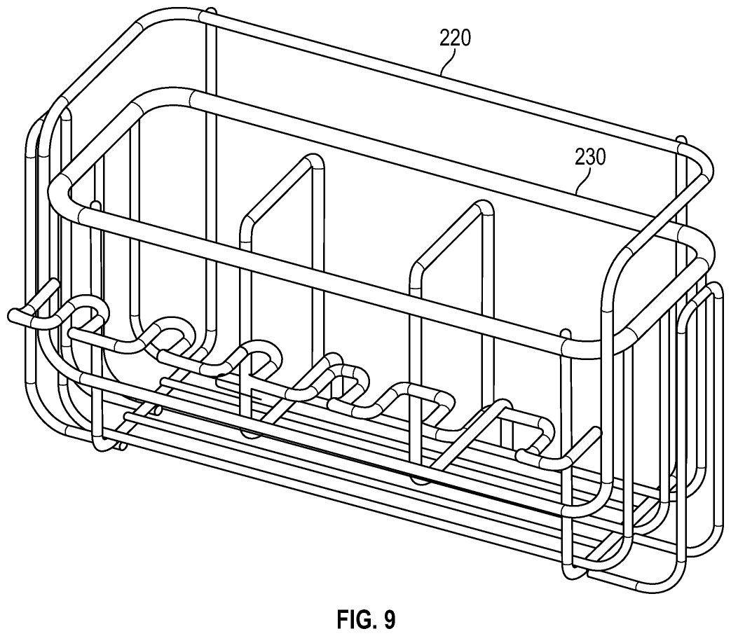

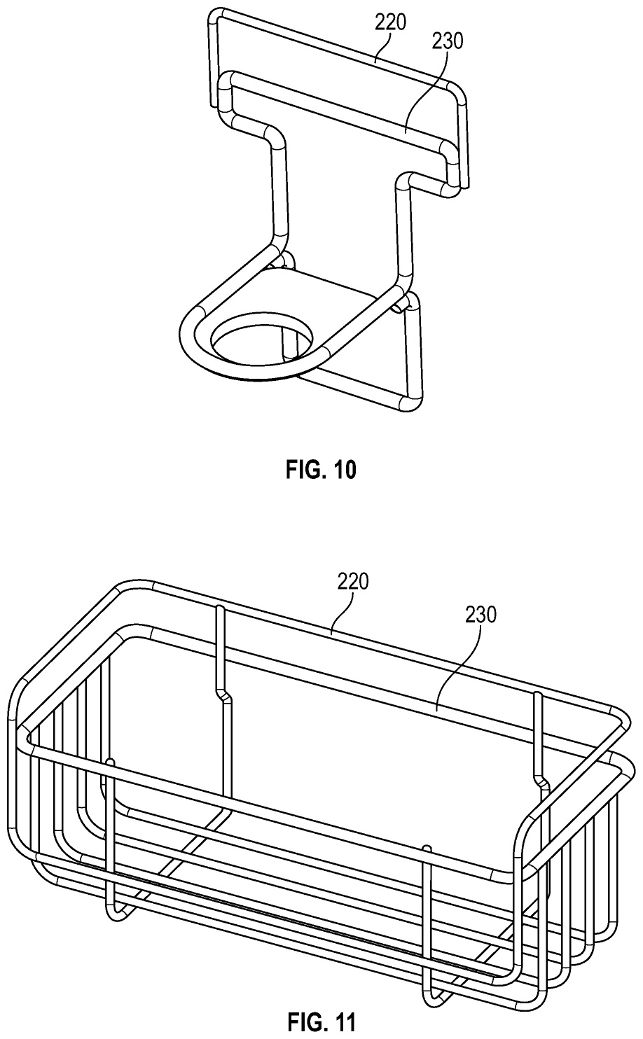

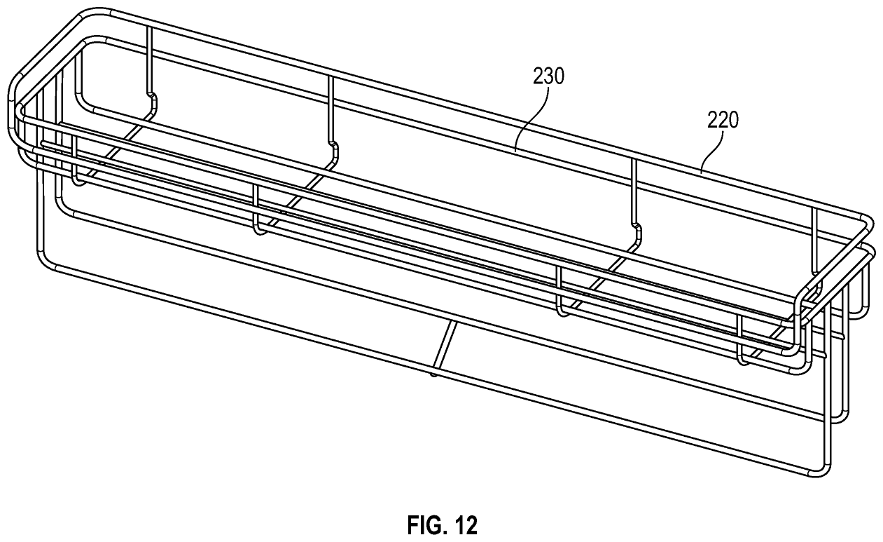

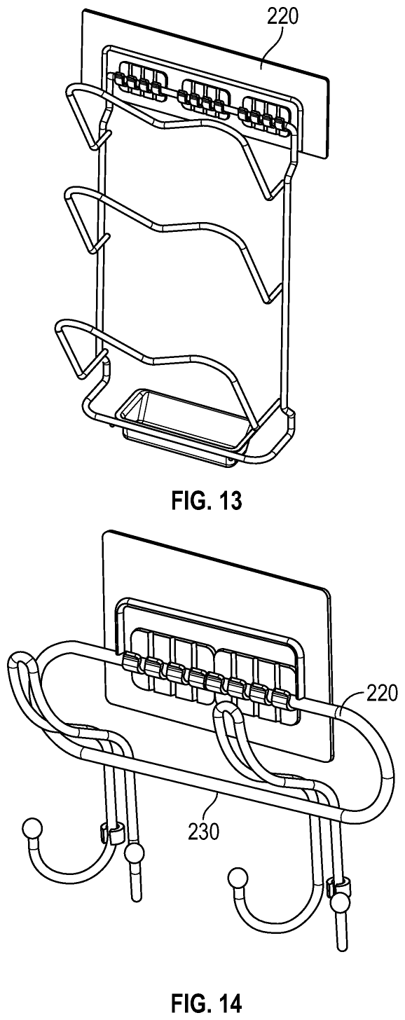

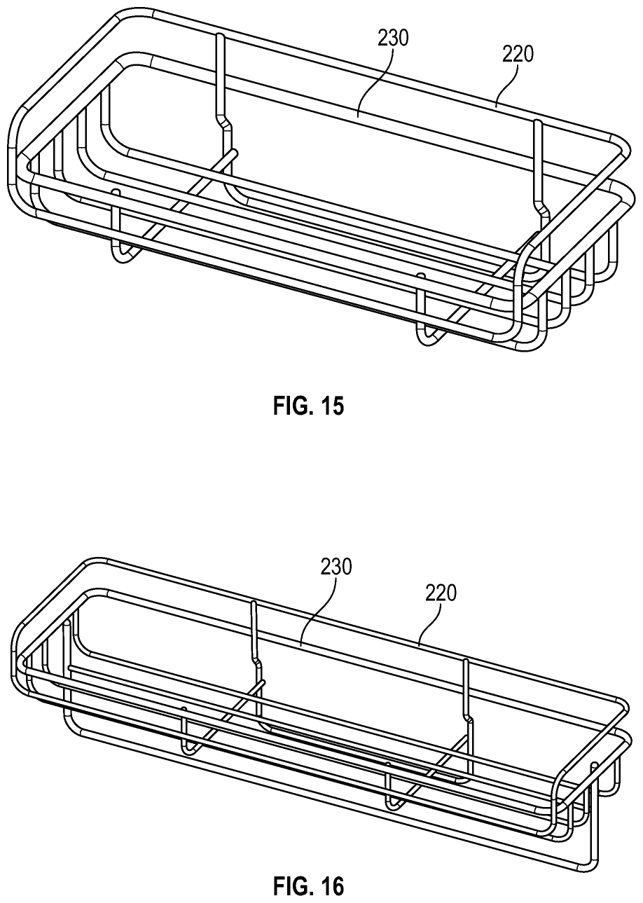

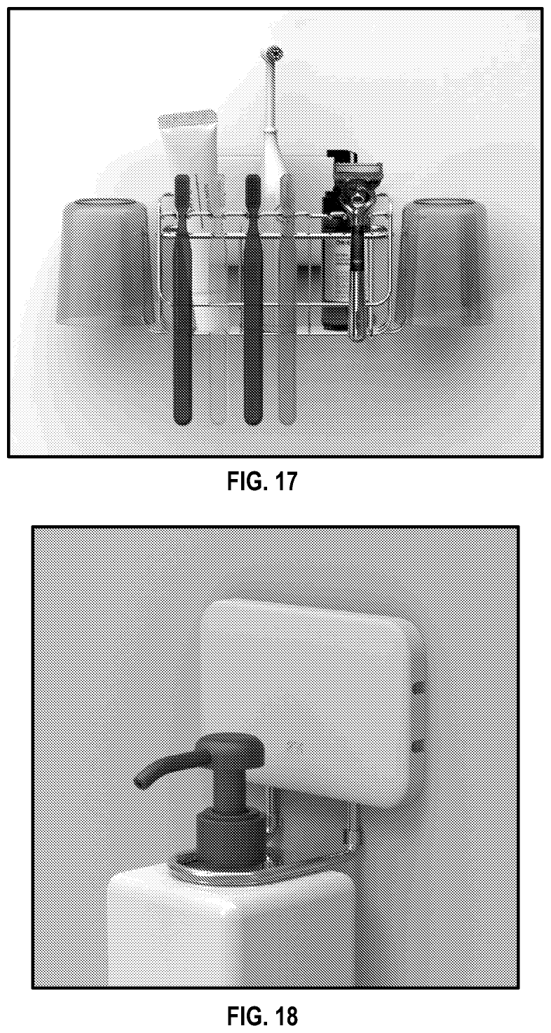

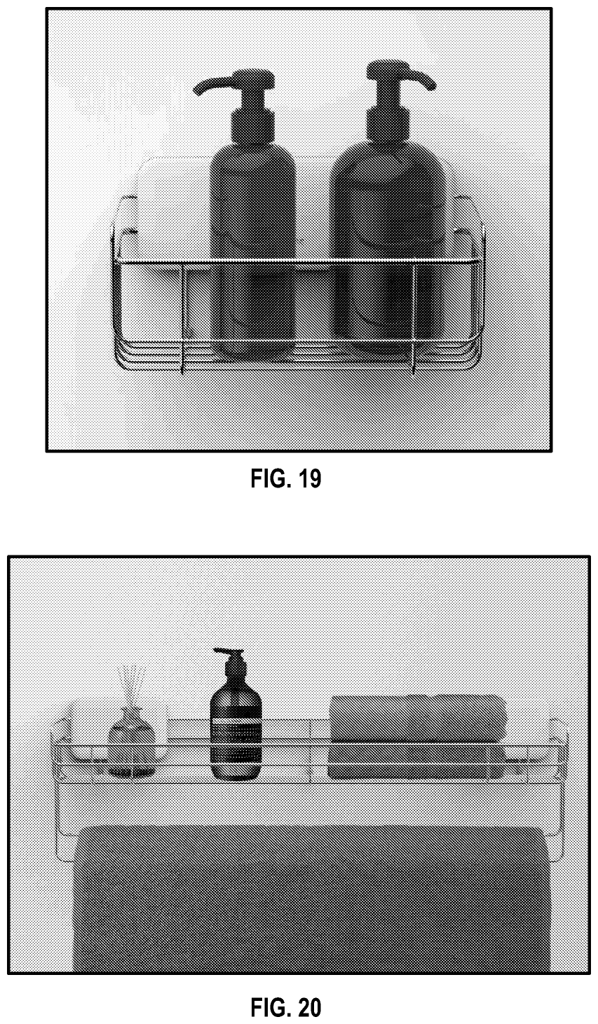

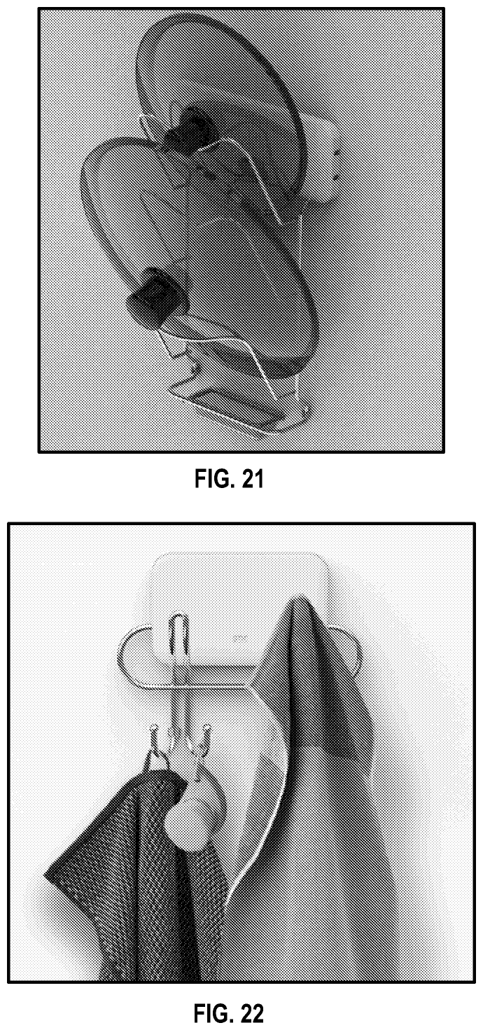

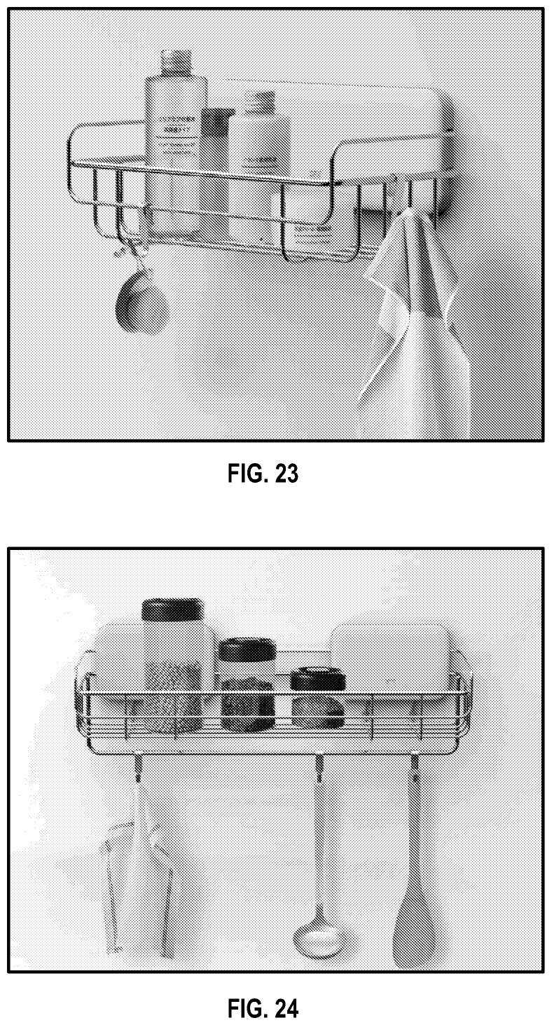

With additional reference to FIG. 2, the storage device 200 includes a main body 210 configured to provide desired storage or organizational attribute(s). For example, in the embodiment shown, the main body 210 is a caddy or basket sized and shaped to receive and contain various articles of interest (e.g., shampoo bottle, soap, body wash, etc.). Alternatively, the main body 210 can consist of or include a shelf, a rail or similar structure and/or can provide other storage features of interest (e.g., a holder configured to retain a particular object such as a hand-held razor, etc.). Even further, the main body 210 can provide multiple shelves, multiple caddies, a single caddy with one or more dividers, etc. Alternatively, the storage device main body 210 can include or carry a mirror. Exemplary storage devices useful in mounting assemblies of the present disclosure are depicted in FIGS. 9-16.

Regardless, the main body 210 has an elongated length defined, for example, by a primary shelf or base 240 (e.g., with the construction of FIGS. 1 and 2, where the main body 210 is a caddy, the shelf 240 constitutes a bottom of the caddy). It will be understood that a construction of the primary shelf 240 is not of particular importance to principles of the present disclosure; rather, reference is made to the primary shelf 240 for purposes of designating an intended orientation of the main body 210 during use. A longitudinal (or length) direction defined or generated by a shape of the elongated main body 200 (e.g., by the shelf 240) is designated by the arrow X in FIG. 2, and a transverse (or height) direction perpendicular to the length by the arrow Y. A depth direction (Z) is into the plane of the page of FIG. 2. In some embodiments, the storage device main body 210 is sized and shaped such that the shelf 240 is intended to be arranged in a horizontal orientation upon final mounting of the storage device 200 to a wall. This orientation is reflected in FIG. 2, with the horizontal direction corresponding with the longitudinal direction X. In this same spatial orientation, the vertical direction corresponds with the transverse direction Y. As made clear below, various other features of the mounting assembly 100 can be described with respect to the horizontal and vertical (or longitudinal and transverse) directions X. Y established by the intended orientation of the storage device 200. It will be understood, however, that the storage device 200, and in particular the main body 210, can be configured for other spatial orientations in which the primary shelf 240 is not necessarily horizontal. The terms “longitudinal” and “horizontal” are used interchangeably throughout this disclosure, as are the terms “transverse” and “vertical”. It should be understood that those terms are used in their relative sense only for ease of explanation and are not limiting. For example. reference to the “horizontal direction” of a feature of a particular object does not limit that object or feature to only being oriented horizontally.

The main body 210 can be made of any desired material or combination of materials. For example and as depicted, the main body 210 may comprise a wire-rod or wire-frame structure (e.g., a wire basket). The wire-frame structure includes at least two wire segments 220. 230 arranged substantially parallel to one another and defining a rear surface of the main body. The wire segments may be continuous across the Y-direction or may include discrete portions (see e.g., FIG. 10). Further, the wire segments 220. 230 are arranged in a plane A that is substantially perpendicular with a plane of the primary shelf 240. The horizontal wire segments 220. 230 may include the same cross-sectional geometry (i.e., shape and dimensions) or different cross-sectional geometry. For instance, the lower wire segment 230 may have larger cross-sectional dimensions (e.g., diameter) than the upper wire segment 220.

In some embodiments, the storage device 200 could be arranged during use such that the plane of the primary shelf 240 is substantially horizontal (i.e., arranged in the horizontal direction X). When so arranged, extension of the wire segments 220, 230 will also be substantially vertical in relation to the primary shelf 240. Alternatively, the wire segment plane A can have other relationships relative to the shelf 240 and/or relative to the environment in which the storage device 200 is mounted. However, the wire segment plane A is substantially aligned with the transverse direction Y in some embodiments.

The main body 210 includes additional, vertical wire segments 250, 260 that extend substantially perpendicular to the generally horizontal wire segments 220, 230. The vertical wire segments 250, 260 may extend between the lower wire segment 230 and the primary shelf 240 and are generally coplanar with plane A encompassing the rear surfaces of the main body 210. In other embodiments, the vertical wire segments 250, 260 may further extend between the upper and lower wire segments 220, 230. Like the horizontal wire segments 220, 230, the vertical wire segments 250, 260 may include the same or different cross-sectional geometry. As can be appreciated, the main body 210, as well as other storage devices depicted herein, include several other wire segments, either discrete or in cooperating arrangements, that help define the shape and function of a given storage device; further description of these segments is not germane to the remainder of the present disclosure.

In other embodiments, a main body can comprise a generally solid structure (e.g., a molded plastic article) that may have one or more perforations (e.g., for drainage, in the event that the assembly 100 is used as a shower caddy). The main body may encompass any conceivable shape and construction, so long as it may be attached to a surface (e.g., wall) as described herein.

The storage device 200 can be coupled to the desired surface via a mounting plate 400 comprised of one or more flexible mounting bodies 410 and an optional backplate 450. The flexible mounting bodies 410 may be made integral with the backplate 450 or may be attached thereto. The flexible mounting bodies 410 each include a load bearing protrusion 440 sized and shaped to receive lower wire segment 230. preferably in snap or press fit relation. While the storage assembly 100 includes three flexible mounting bodies 410, the number of flexible mounting bodies 410 can be reduced or increased depending on the size of the storage device. For instance and in other embodiments featuring storage devices with smaller lengths along the X-direction, the mounting plate 400 may include one or two flexible mounting bodies 410. For heavier weight or longer storage devices, the mounting plate may include four or more mounting bodies 410.

Each flexible mounting body 410 includes a plurality of body segments 420 that cooperate to define the shape and perimeter of the mounting body 410. The body segments 420 each include a hook segment +41 cooperating to define the load bearing protrusion. Adjacent body segments 420 are coupled by a shared connector segment 430. The flexible body 410 is accordingly comprised of a plurality (n) of body segments 420, and an (n-1) corresponding number of connector segments 430. The plurality of body segments 420 are each spaced from one another by a certain pitch (e.g., center to center distance) “D” and are directly connected to any adjacent body segments only at connector segments 430. The body segments 420, as depicted, are both wider in the horizontal X direction and thicker in the Z direction than the connector segments 430. Accordingly, the body segments 420 are free to flex in at least the horizontal direction.

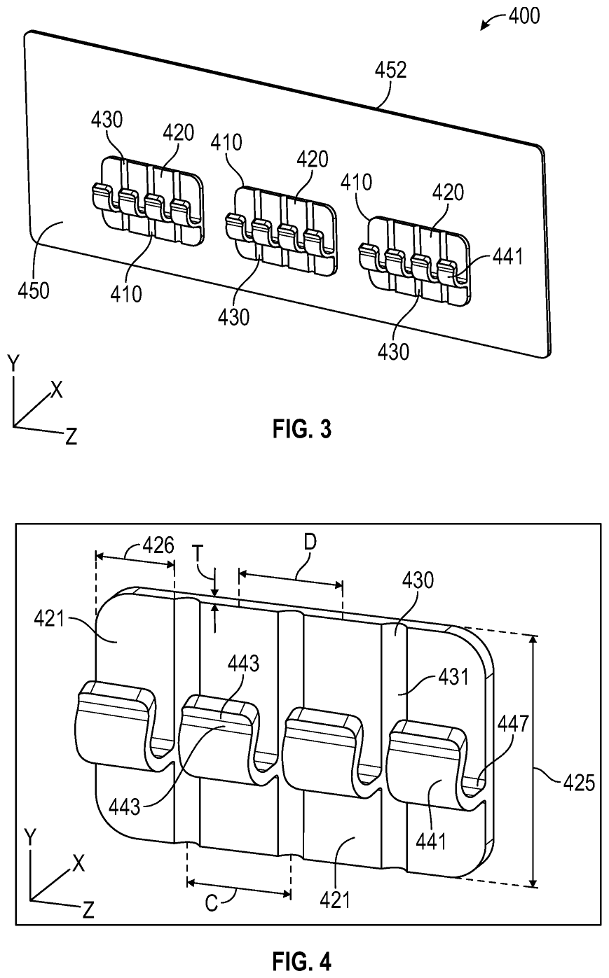

As shown best in FIGS. 3 & 4, the body segments 420 are arranged about a central, horizontal axis of the mounting body 410. The body segments +20 extend perpendicular to the central axis and are continuous in the Y-direction. In other implementations, the body segments 420 need not be arranged in substantial parallel and instead may take on a sinusoidal configuration. Alternatively, the body segments 420 may be arranged as a triangular wave, a sawtooth wave, or in a radial pattern, to identify a few non-limiting examples. Other suitable flexible mounting bodies may be found in International Publication No. WO2020/128911 (Khodaparast et al.).

Each body segment +20 and connector segment 430 includes a cross-sectional thickness “T” in the z-direction. In the depicted article, the cross-sectional thickness is continuous throughout the dimensions of each body segment 420 and connector segment 430. In other embodiments, the cross-sectional thickness T may be thicker near the center of the flexible mounting body 410 than the edge(s) or vice versa. In some such embodiments, the cross-sectional thickness may include a tapering thickness as either the center or the edge of the body 410 is approached. In some embodiments, the body segments 420 have a maximum thickness, that is at the thickest point in the Z-direction, of between about 20 mils and about 200 mils. In the same or other embodiments, the connector segments 430 have a maximum thickness of between about 5 mils and 20 mils. Flexibility in the horizontal direction can be influenced by adjusting the relative thickness of the connector segments 430 and body segments 420, with relatively thinner connector segments demonstrating more flexibility.

Connector segments 430 serve as a connective web between body segments and may extend the full vertical (Y-direction) length of the adjoined body segments 420 as depicted in FIGS. 3 & 4. In other embodiments, the connector segments 430 can be discontinuous or may extend less than the full vertical length of the body segments. Reducing the amount of connector segment material between the body segments tends to increase the X-direction flexibility of the flexible mounting body 410. Care should be taken, however, to avoid small concentrations of shear stress when the load bearing projections are used to connect to the main storage device 200.

The arrangement of body segments 420 in flexible mounting body 410 results in the pitch “D” being substantially the same across the length of the mounting body. Flexibility can be affected by increasing or decreasing the pitch “D” (i.e., frequency) between adjacent segments or along the length of adjacent segments, which tends to also change the size of and pitch “C” between the center of adjacent connector segments 430. An exemplary range for both pitch D and pitch C is between about 0.05 inches and 0.5 inches, with pitch D and pitch C commonly (but not exclusively) substantially the same distance.

Flexibility may also be affected changing the arrangement of the body segments or by increasing or decreasing the number of body segments 420 (and corresponding connectors 430), meaning that the absolute number of body segments 420 is not critical; more than three or more than five can provide sufficient performance, depending on the intended end use. The body segments 420 resist peel in directions substantially parallel to the Y-direction. This designed resistance allows the flexible body to hold mounting weight and demonstrate requisite shear strength while still permitting manipulation of the segments to case removal.

As depicted in of FIGS. 2-4, the body segments 420 are generally rectangular in shape, however, the body segments 420 may reflect a variety of shapes. For example, the shape of one or more body segments 420 may be a polygon (e.g., square, tetrahedron, rhombus, trapezoid), which may be a regular polygon or not, or the cross-sectional shape of a body segment can be curved (e.g., round or elliptical). Each body segment 420 possesses a length 425 and a width 426, with the length 425 typically being greater than the width. The comparatively greater length 425 aids in the shear holding power of the flexible body when weight is applied (generally at load bearing protrusion 460) in the Y-direction. In one exemplary embodiment, a ratio of the length to the width is at least 15:1. An exemplary range of lengths 425 for each linear segment is between about 0.8 inches to 6 inches, while an exemplary range of widths 426 is between about 0.05 inches and about 0.3 inches.

The first major surfaces 421. 431 of the body segments 420 and connectors 430 define the front major surface 411 of the flexible mounting body 410, while the second major surfaces (not shown) of the same define a rear major surface of the flexible body 410. The major surfaces also cooperate to define a first body plane and the second major surfaces cooperate to define a second body plane. The body planes as depicted are in parallel but may intersect and form an oblique angle in other embodiments.

The side edges of the flexible mounting bodies 410 may be provided with flaps or other projecting structures that aide in the removal of the body from a mounting surface. The flaps generally extend long the X-axis and can be used to initiated peel front or provide better user purchase.

The load bearing protrusion 440 juts outwardly from the front major surface 411 of each flexible mounting body 410. The projection 440 includes a plurality of curved hook segments 441 coupled to a corresponding body segment 420. The hook segments 441 are separated and discrete from one another. A distal hook finger 443 of each hook segment 441 extends about a plane substantially parallel to its corresponding body segment 420. A recess 447, formed between a surface of each body segment 420 and the hook segments 441 can accept the lower wire segment 230 or like structure on an item to be mounted. The recess 447 can have a generally circular cross sectional share as depicted but typically shares the cross-sectional shape of corresponding wire segment. The distance between the hook finger 443 may be less than the cross-sectional dimensions of the recess 447 or wire segment 230, requiring the finger 443 to flex away from the body 410 to accept the wire segment 230 and return to an initial state to prevent inadvertent decoupling of the storage device 200.

In presently preferred embodiments, all elements of the flexible mounting body are unitary or monolithic, in that they are made of a single piece of material. In other embodiments, the constituent elements may be made separately and joined together to form the flexible body. Exemplary materials and constructions for the flexible mounting body are explored in further detail below.

The backplate 450 extends beyond the periphery of each flexible mounting body 410 and includes a length and width each exceeding the corresponding dimensions of each flexible mounting body 410, as well as the aggregate dimensions of the same. The thickness of the backplate 450 is typically less than the corresponding thickness of the body 410, allowing for greater flexibility despite the typically monolithic nature of the backplate 450. An adhesive layer (not shown) can be affixed to a rear major surface 452 of the backplate 450.

The backplate may be advantageous in obscuring an aesthetically undesirable adhesive layer and may provide additional rigidity to the adhesive article to aid in bearing the weight of a mounted object. The backplate may be integrally made with the flexible mounting body or may be made separately and affixed thereafter.

Materials forming the backplate can include natural or synthetic polymer films, fabric reinforced polymer films, fiber or yarn reinforced polymer films or nonwovens, fabrics such as woven fabric formed of threads of synthetic or natural materials such as cotton, nylon, rayon, glass, ceramic materials, and the like, or combinations of any of these materials. The backplate may also be formed of metal, metallized polymer films, or ceramic sheet materials in combination with at least one of the above. In some embodiments, the backplate is a multilayered film having two or more layers; in some such embodiments the layers are laminated. For example, the backplate can be formed of a foam, a polymer film, or a combination thereof with any suitable thickness, composition, and opaqueness or clarity. Exemplary materials and constructions for the backplate are explored in further detail below.

A mounting adhesive layer (not shown in FIG. 1) can be disposed on the rear major surface 452 of the backplate 450. The mounting adhesive layer can be a single layer or can be multilayer. The adhesive layer can be continuous or discontinuous (e.g., patterned) across the rear major surface 452. An available bond area for the assembly 100 includes the total area defined by the outer surface of the adhesive layer.

In embodiments lacking a backplate, the available bond area may or may not include the connector segments 430. The available bond area is used to couple the adhesive mounting body 410 to, for example, a wall surface. In other exemplary embodiments, an assembly 100 may lack an adhesive layer on the second major surface of the backplate. For instance, the second major surface may include one component (e.g., a hook or loop structure) of a separable connector. Suitable separable connectors may be found in U.S. Pat. Nos. 6,692,807 (Bries et al.) and U.S. Pat. No. 9,920,786 (Runge et al.).

The mounting adhesive layer is typically no more than coextensive with the major surfaces 451, 452 of the backplate. In other embodiments not pictured, the adhesive layer can extend beyond the perimeter of the backplate. The thickness of the adhesive layer(s) is not particularly limited but is typically substantially continuous across the rear major surface 452. In presently preferred implementations, the thickness of the adhesive layer is no greater than 95% of the body thickness “T”, no greater than 90%, no greater than 80%, no greater than 75%, no greater than 60%, no greater than 50%. no greater than 40%, no greater than 30%, no greater than 20%, and in some embodiments no greater than 10% of the body thickness “T”. In typical embodiments, the adhesive layer 140 has a thickness of between about 1 mil and about 8 mils.

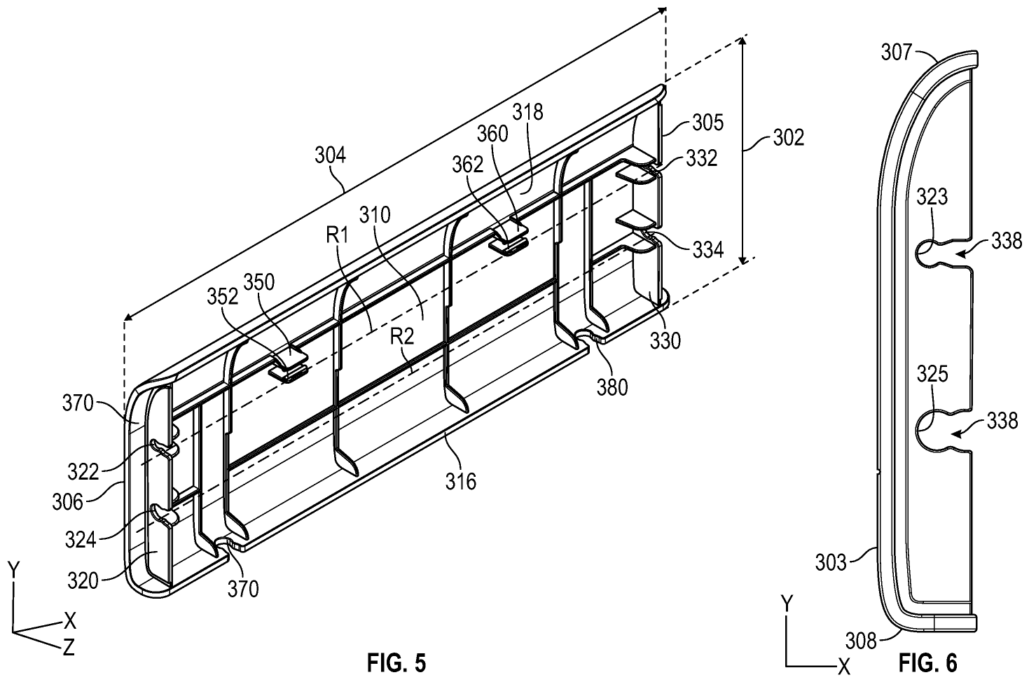

Turning to FIG. 5, the aesthetic cover 300 has a length 302 and a width 304 each commensurate or greater than the corresponding dimensions of mounting plate 400. The cover 300 also includes a shape configured to substantially match that of the mounting plate 400, is accordingly rectangular in the depicted embodiment. In this way, the cover 300 obscures the mounting plate 400 from view once fully assembled. The front surface 303 of the cover 300 may include indicia, brand information, or instructions for using the storage assembly 100. The edges 305, 306, 307, 308 of the cover may include beveling or other curvature.

The cover 300 may include a rear cavity 310 for receipt of the flexible mounting bodies 410 and wire segments 220, 230. The cavity 310 can be defined by sidewalls 320. 330 protruding from the back surface 312 of the cover 300, top wall 318, and a bottom wall 316. A top wall 318 can be provided by curved top edge 307 or may be a discrete structure like bottom wall 316. The sidewalls 320, 330 are set off a certain distance from horizontal edges 305 and 306, which creates awnings 370, 372 to further obscure the point of connection between the storage device 200 and the cover 300.

The sidewalls 320, 330 may extend the full vertical (Y-direction) height of the cavity 310 or may extend along only a central portion thereof. The sidewall 320 includes recesses acting as retention notches 322, 324, while sidewall 330 includes retention notches 332, 334. The retention notches 322 and 332 are arranged along a first horizontal axis R1, while retention notches 324 and 334 are similarly arranged about a second horizontal axis R2 at least substantially parallel to the first axis. Each retention notch 322, 324, 332, 334 is sized and shaped to retain a portion of a wire segment 220 or 230, with the upper segment 220 intended for receipt in retention notches 322 and 332 and the lower segment 230 intended for receipt in retention notches 324 and 334.

Each retention notch 322, 324, 332, 334 may terminate in a well 323, 325, 333, 335 having dimensions commensurate with the cross-sectional dimensions (e.g., diameter) of a corresponding wire segment 220 or 230. Each retention notch 322, 324, 332, and 334 may include an opening 338 including tapered edges to create a funnel into the respective well. The sidewalls 320, 330 can be made of a sufficiently resilient material such that the opening 338 is allowed to expand as the cover 300 is pressed onto the wire segments 220, 230.

The cavity 310 may include clips 350. 360 arranged along the first horizontal axis R1. Each clip 350, 360 may include opposing ridges 352, 362 spaced apart along the Y-direction, the distance between the ridges generally corresponds to the cross-sectional dimensions of upper wire segment 220. The ridges 352, 362 further constrain movement, especially rotation away from the wall, of the storage device 200 when the cover 300 is assembled to the wire segments 220, 230.

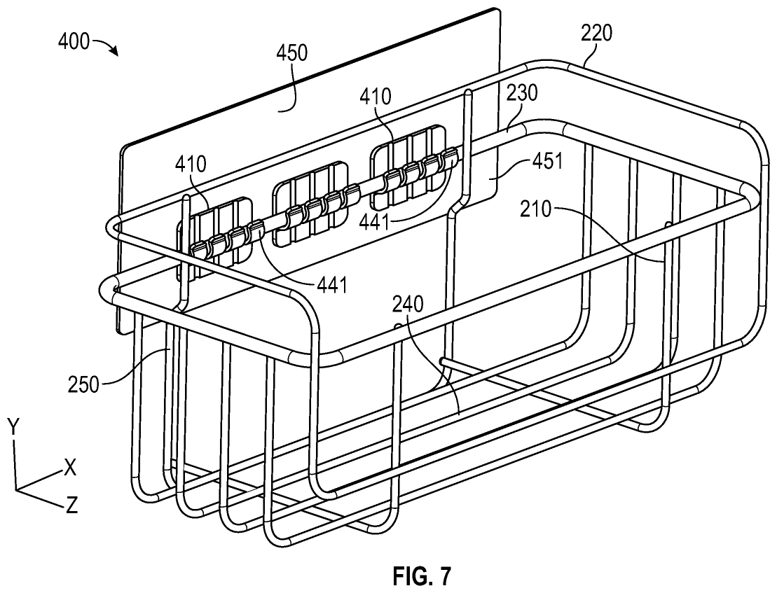

Vertical wire segments 250. 260 can also find purchase in retention notches 370, 380 in the bottom wall 218. The retention notches 370, 380 share many of the same features as retention notches 322, 324, 332 and 324, which need not be repeated again. The retention notches 370, 380 can aid in inhibiting horizontal movement of the storage device 200 relative to the mounting plate 400, reducing the potential for inadvertent adhesive removal or failure of the flexible mounting body 410. To install the storage assembly 100, the mounting plate 400 is first affixed to a surface (e.g., wall) at the user's desired location using the adhesive layer. The upper wire segment 220 can then be clipped or otherwise coupled to the hook segments 441 on the plurality of flexible mounting bodies 420. The main body 210 may optionally be rotated in the direction of the mounting surface such that the lower wire segment 230 abuts or is otherwise adjacent to that surface (as shown in FIG. 7). The upper and lower wire 220. 230 segments are preferably but not exclusively coplanar in a plane parallel to the front surface of the mounting plate 400 (as depicted, front surface 451 of the backplate 450). The cover 300 may then be pressed towards the wall, ensuring that the upper wire segment 220 is received in retention notches 322, 332 and between clips 350, 360. Pressing the cover towards the mounting surface can also result in the lower wire segment 230 received in retention notches 324, 334 and the vertical wire segments 250, 260 received in the retention notches 370, 380 in the bottom wall 318.

Alternatively, the elements of storage assembly 100 can be coupled together before mounting the mounting plate 400 to the desired mounting surface.

An alternative embodiment of a mounting plate 500 is depicted in FIG. 8. The mounting plate 500 is particularly, but not exclusively, well suited for use with stretch-releasable adhesive strips. The mounting plate 500 includes a backplate 510 having a first major surface 511 and an opposing second major surface 512. A plurality of stiffening fins (i.e., body segments) 550a-550f protrude outward from and extend the vertical length of the first major surface 511. Similar to mounting plate 400, the fins 550a-550f are arranged about a central, horizontal axis 518 of the backplate 1010. The plurality of fins 550a-550f extend perpendicular to the central axis 518 and are continuous along the surface 511 of the backplate 510 in the Y-direction. The plurality of fins 550a-550f are each spaced from one another along the horizontal direction by a certain pitch “D” and are not directly connected to one another except through shared coupling to the backplate 510.

Each fin possesses a length along the vertical Y-direction, and a width in the X-direction, with the length typically being substantially greater than the width, which is relatively thin by design. The comparatively greater length aids in the shear holding power of the flexible body when weight is applied in the Y-direction. In one exemplary embodiment, a ratio of the length to the width is at least 15:1. An exemplary range of lengths for each linear segment is between about 0.8 inches to 6 inches, while an exemplary range of widths is between about 0.03 inches and about 0.3 inches.

The plurality of fins each protrude to a certain height “H” in the Z-direction, as measured from the front surface 511 to the outermost face 552 of each fin 550a-550f. As depicted, the height H of each fin is greater near the center of the flexible mounting body 510 than the edge(s) 515. This tapering height provides greater strength at a load bearing projection 560. In other embodiments, the height “H” is continuous over the full vertical direction or has an increasing taper towards the edge 515. An exemplary suitable height H for the fins is 80-100 thousandths, tapering down to 60 thousandths.

The stiffening fins 550a-550f can be arranged in groups of three sharing a common pitch “D”. Fin group 551 includes stiffening fins 550a-550c, while group 553 includes stiffening fins 550d-550f. Fins within the group 551, 553 are separate by the same pitch D, while group edge fins 550c and 550d are separated by a greater distance. This arrangement tends to maximize the stiffness of the mounting body 500 above (in the Z-direction) stretch release adhesive strips (e.g., COMMAND adhesive strips). IN this manner, the mounting plate 500 is relatively rigid as compared to flexible mounting bodies 410. A load bearing surface 560 extends outwardly from the front major surface 552 of each fin 550b-550e. The surface 560 includes a plurality of hook segments 561b-561e coupled to a corresponding fin 550b-550e. The hook segments 561b-561e are separated and discrete from one another. Exterior fins 550a and 550f in other embodiments not depicted may lack a corresponding hook segment, allowing an attached storage device or other hardgood to pivot against fins 550a. 550f to aid in stability. A distal hook finger 563 of each hook segment 561 extends in a plane substantially parallel to its corresponding fin 550. A recess 567, formed between a surface of each fin 550b-550fd and the hook segments 561d-561e can accept a wire segment 220, bracket, or other cross-bar structure attached to a storage device or hardgood to be mounted. A protrusion 564 can be formed on the face 552 of each fin 550 within the recess 567, preventing inadvertent removal of the wire, bracket, or cross-bar from the recess 567 once seated. The hook segment 561 further includes a support wall 568, integral with the corresponding fin 550, below the bottom surface of the recess 567 to provide further structural support for the storage device 200 when coupled to the mounting plate 500 and installed on the vertical surface of choice.

Constituent elements of the adhesive mounting articles of the present disclosure will be explored in more detail below.

### Flexible Mounting Body & Cover

In some embodiments, the flexible mounting body and cover are made from of thermoplastic polymers. In some embodiments, the flexible mounting body and cover are made from thermoset polymers. In some embodiments, the flexible mounting body and cover are made using polyolefin materials. In some embodiments, the flexible body is made using polycarbonate materials. In some embodiments, the flexible mounting body and cover are made using high-impact polystyrene (HIP). In some embodiments, the flexible mounting body and cover are made using acrylonitrile-butadiene-styrene (ABS) terpolymers. In some embodiments, the flexible mounting body and cover are made of polyetheretherketone (PEEK). In some embodiments, the flexible mounting body and cover are made from nylon. In some embodiments, the flexible mounting body and cover are made using two or more polymeric materials. In some embodiments, the flexible mounting body and cover are made from metal. In some embodiments, the flexible mounting body and cover are made from stainless steel. In some embodiments, the metal is painted, glazed, stained, brushed, or coated to alter its appearance. In some embodiments the flexible mounting body and cover are made from ceramic. In some embodiments, the flexible mounting body and cover are made from glazed ceramic. In some embodiments, the flexible mounting body and cover are made from unglazed ceramic. In some embodiments, the flexible mounting body and cover are comprised of naturally-based materials such as wood, bamboo, particle board, cloth, canvas, or derived from biological sources, and the like. In some embodiments, the naturally-based materials may be painted, glazed, stained, or coated to change their appearance. In some embodiments, the flexible mounting body and cover are made using two or more materials from the list above. In some embodiments, the flexible mounting body and cover are made from two pieces that are reversibly or irreversibly attached, joined, or welded together.

The flexible mounting body and cover can be made of a rigid material such as, for example, thermoplastic materials including polycarbonate, polyesters, and ABS. In some embodiments, depending on the exact application, rigid polyvinyl chloride, HIP, PEEK, or nylon may be used. It is to be understood that the flexible mounting body and cover can be made of any suitable material providing appropriate loading strength in the y-direction.

The flexible mounting body and cover can be made using any method known in the art. In presently preferred implementations, the flexible mounting body and cover are made as an integral unit by injection molding, additive manufacturing (e.g., 3D printing, selective laser sintering, selective laser melting, rapid prototyping, etc.) resin transfer molding, compression molding, and the like.

In some embodiments, the flexible mounting body comprises two pieces wherein the first piece acts as a mounting surface for attaching the storage assembly to a substrate or backplate, and the second piece acts as a hanging member which may be used for hanging or mounting objects (e.g., storage devices) to the substrate. The two pieces may be reversibly attached using mechanical fasteners, hook and loop materials, or an additional adhesive layer.

In some embodiments, an adhesive layer(s) may be attached to the flexible mounting body using a lamination process. In some embodiments, the adhesive layer(s) and body may be attached to the flexible mounting body using multiple lamination processes. In some other embodiments, the adhesive layer(s) may be attached manually by the end user or manufacturer.

In some embodiments, the mounting projection may be attached to the flexible body using two or more injection molding steps in using one or more molds.

### Backplate

The backplate can be a single layer or a multilayer construction. More than one layer of material can be present in the backplate. Multiple layers can be separated by layers of film, which may further contain one or more layers. In some embodiments, two or more sub-layers can be co-extruded or laminated so as to form the carrier backing. In some embodiments, the backplate is flexible. Some embodiments include dyes or pigments in the carrier layer(s).

In some embodiments, the backplate is or includes a foam composite that includes a flexible polymeric foam layer, a film laminated to a first major surface of the foam layer. Adhesive(s) can be attached to the films to form a structure of adhesive-foam-film. The flexible polymeric foam layer can be chosen to optimize conformability and resiliency properties which are helpful when an adhesive assembly is to be adhered to surfaces having surface irregularities, such as a typical wall surface. An exemplary flexible polymeric foam layer is commercially available under the trade designation “Command” from 3M Company of St. Paul. Minn. In some embodiments, the flexible polymeric foam layer of the core can include polyolefin foams which are available under the trade designations “Volextra” and “Volara” from Voltek. Division of Sekisui America Corporation. Lawrence. Mass. In some embodiments, the backplate is or includes a metal or is metal-like.

Polymeric foams can include open-celled foams, closed-celled foams or combinations thereof. In some embodiments, the foam can be surface modified by thermal, chemical (e.g., acid-etching, corona treatment, plasma etching, glow discharge, or flame treatment), and/or photochemical (e.g., ultraviolet irradiation) processes. In certain embodiments, the polymeric foam has a void volume of at least 20 volume %, at least 30 volume %, at least 40 volume %, at least 50 volume %, and at least 55 volume %. In certain embodiments, the polymeric foam has a void volume of at most 70 volume %, preferably at most 65 volume %, more preferably at most 60 volume %. For polymeric foams in which the bulk density of the polymer is typically near 1. foam densities can be closely correlated with void volumes. Thus, denser foams are preferred, as they typically provided the desired increase in relative stiffness as compared to the exterior adhesive construction.

In many embodiments of the present disclosure, the backplate may include or consist of a polymeric film. Polymeric film layers can be in a variety of forms including, for example, a single-layer or multi-layer film, a porous film, and combinations thereof. The polymeric film may contain one or more fillers (e.g., calcium carbonate). The polymer film can be a continuous layer or a discontinuous layer. Multi-layer polymer films are preferably integrally bonded to one another in the form of a composite film, a laminate film, and combinations thereof. Multilayer polymeric films can be prepared using any suitable method including, for example, co-molding, coextruding, extrusion coating, joining through an adhesive, joining under pressure, joining under heat, and combinations thereof.

The film may comprise a single polymeric material or may be prepared from a mixture of polymeric materials. Examples of suitable materials include polyesters such as polyethylene terephthalate, polyethylene naphthalate, copolyesters or polyester blends based on naphthalene dicarboxylic acids; polycarbonates; polystyrenes; styrene-acrylonitriles; cellulose acetates; polyether sulfones; poly(meth)acrylates such as polymethylmethacrylate; polyurethanes; polyvinyl chloride; polycyclo-olefins; polyimides; or combinations or blends thereof.

Particularly suitable polymeric materials are rigid material such as those used for the flexible mounting body, for example, thermoplastic materials including polycarbonate, polyesters, and ABS. In some embodiments, depending on the exact application, rigid polyvinyl chloride. HIP. PEEK, or nylon may be also used in the polymeric film layer. In presently preferred circumstances, the polymeric film layer is the same or similar polymeric material as the flexible body.

Thin layers of additional polymers (tie layers) may be present to improve the adhesion of layers in the backplate that are not naturally adhesive to each other. For example, a layer of silicone may be used to increase the adhesion between a polycarbonate film layer and polyolefin foam. Other suitable tie layers can include rubber-based and acrylate-based tie layers. In present implementations, the silicone tie layer is particularly well suited for high humidity or high temperature environments.

### Mounting Adhesive Layer(s)

The mounting adhesives used in the adhesive articles described herein can include any adhesive having the desired properties. In some embodiments, the adhesive is peelable. In some embodiments, the peelable adhesive releases from a surface of an adherend when an article is peeled at an angle of about 35° or greater from the adherend surface such that there are substantially no traces of the adhesive left behind on the surface of the adherend.

In other embodiments, the adhesive can be stretch releasable. Suitable stretch-releasing adhesive can comprise an elastic backing, or a highly extensible and substantially inelastic backing, with a pressure-sensitive adhesive disposed (e.g., coated) thereupon. In some embodiments, the adhesive releases from a surface of an adherend when an article is peeled at an angle of about 35° or less from the adherend surface such that there are substantially no traces of the adhesive left behind on the surface of the adherend.

In some embodiments, the mounting adhesive is a pressure sensitive adhesive. Any suitable composition, material or ingredient can be used in the pressure sensitive adhesive. A general description of useful pressure sensitive adhesives may be found in the Encyclopedia of Polymer Science and Engineering. Vol. 13. Wiley-Interscience Publishers (New York. 1988). Additional description of useful pressure-sensitive adhesives may be found in the Encyclopedia of Polymer Science and Technology, Vol. 1, Interscience Publishers (New York. 1964). Pressure sensitive adhesive compositions are well known to those of ordinary skill in the art to possess properties including the following: (1) tack. (2) adherence with no more than finger pressure. (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Suitable PSAs may be based on crosslinked or non-crosslinked (meth)acrylics, rubbers, thermoplastic elastomers, silicones, polyurethanes, and the like, and may include tackifiers in order to provide the desired tac, as well as other additives. In some embodiments, the PSA is based on a (meth)acrylic PSA or at least one poly(meth)acrylate, where (meth)acrylate refers to both acrylate and methacry late groups. In some embodiments, the PSA is an olefin block copolymer based adhesive. Acrylic based pressure sensitive adhesives are described in U.S. Pat. No. 4,726,982 (Traynor et al.) and in U.S. Pat. No. 5,965,256 (Barrera), for example. Silicone based pressure sensitive adhesives are described in U.S. Pat. No. 6,730,397 (Melancon et al.) and U.S. Pat. No. 5,082,706 (Tangney), and US Patent Publication 2021/0238463 (Khodaparast et al.), for example. Polyurethane based pressure sensitive adhesives are described in U.S. Pat. Appl. Pub. No. 2005/0137375 (Hansen et al.), for example. Olefin block copolymer based pressure sensitive adhesives are described in U.S. Pat. Appl. Pub. No. 2014/0335299 (Wang et al.). for example.

Exemplary pressure sensitive adhesives utilize one or more thermoplastic elastomers, e.g., in combination with one or more tackifying resins. In some embodiments, the adhesive is not a pressure sensitive adhesive.

In some embodiments, the adhesive layer can include at least one of rubber, silicone, or acrylic based adhesives. In some embodiments, the peelable adhesive layer can include a pressure-sensitive adhesive (PSA). In some embodiments, the peelable adhesive can include tackified rubber adhesives, such as natural rubber; olefins; silicones, such as silicone polyureas or silicone block copolymers; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations of the above.

In presently preferred embodiments, the mounting adhesive includes at least one of a silicone polyurea and other silicone block copolymers. Such adhesive can include at least one of (1) a polydiorganosiloxane polyoxamide copolymer, a silicate tackifying resin in an amount of between about 10 wt % and about 70 wt %, and inorganic particle filler in between about 0.1 wt % and about 20 wt %; (2) a silicone polyurea block copolymer, a silicate tackifying resin in an amount of between about 10 wt % and about 70 wt %, and inorganic particle filler in an amount between about 0.1 wt % and about 20 wt %; and (3) an addition cure silicone, a silicate tackifying resin in an amount of between about 10 wt % and about 70 wt %, and inorganic particle filler in an amount between about 0.1 wt % and about 20 wt %. The inorganic filler is typically fumed silica. In some embodiments, the polydiorganosiloxane polyoxamide contains at least two repeat units of Formula I.

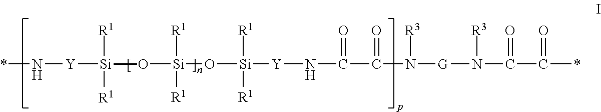

In this formula, each R¹ is independently an alkyl, haloalkyl, aralkyl, alkenyl, aryl, or aryl substituted with an alkyl, alkoxy, or halo, wherein at least 50 percent of the R¹ groups are methyl. Each Y is independently an alkylene, aralkylene, or a combination thereof. Subscript n is independently an integer of 40 to 1500 and subscript p is an integer of 1 to 10. Group G is a divalent group that is the residue unit that is equal to a diamine of formula R³HN—G—NHR³ minus the two —NHR³ groups (i.e., amino groups). Group R³ is hydrogen or alkyl or R³ taken together with G and with the nitrogen to which they are both attached forms a heterocyclic group. Each asterisk (*) indicates a site of attachment of the repeat unit to another group in the copolymer such as, for example, another repeat unit of Formula I. In some embodiments, the silicone containing polymer is formed by an addition cure reaction between vinyl-terminated poly (dimethylsiloxane) (PDMS) and hydrogen terminated PDMS, in the presence of a hydrosilation catalyst (e.g., platinum complex).

Tackifying resins such as silicate tackifying resins are added to the polydiorganosiloxane polyoxamide copolymer to provide or enhance the adhesive properties of the copolymer. The silicate tackifying resin can influence the physical properties of the resulting adhesive composition. For example, as silicate tackifying resin content is increased, the glassy to rubbery transition of the adhesive composition occurs at increasingly higher temperatures. In some exemplary adhesive compositions, a plurality of silicate tackifying resins can be used to achieve desired performance. Suitable silicate tackifying resins include those resins composed of the following structural units M (i.e., monovalent R′₃SiO_{1/2} units), D (i.e., divalent R′₂SiO_{2/2} units), T (i.e., trivalent R′SiO_{3/2} units), and Q (i.e., quaternary SiO_{4/2} units), and combinations thereof. Typical exemplary silicate resins include MQ silicate tackifying resins, MQD silicate tackifying resins, and MQT silicate tackifying resins. These silicate tackifying resins usually have a number average molecular weight in the range of 100 to 50,000 or in the range of 500 to 15,000 and generally have methyl R′ groups.

Further considerations regarding these tackified and filled silicone adhesives may be found in US Patent Publication 2021/0238463 (Khodaparast et al.).

Generally, any known additives useful in the formulation of adhesives may also be included. Additives include plasticizers, tackifiers, anti-aging agents, ultraviolet stabilizers, colorants, thermal stabilizers, anti-infective agents, fillers, crosslinkers, as well as mixtures and combinations thereof. In certain embodiments, the adhesive can be reinforced with fibers or a fiber scrim which may include inorganic and/or organic fibers. Suitable fiber scrims may include woven-, non-woven or knit webs or scrims. For example, the fibers in the scrim may include wire, ceramic fiber, glass fiber (for example, fiberglass), and organic fibers (for example, natural and/or synthetic organic fibers).

In some embodiments, the thickness of the peelable adhesive on at least one of the first or second major surfaces of the core is about 1 μm to about 1 mm.

In some embodiments, adhesion properties of the adhesive can range from 0.1 N/dm to 25 N/dm. In some embodiments, adhesion properties of the adhesive can range from 0.5 N/dm to 10 N/dm. In some embodiments, adhesion properties of the adhesive can range from 1 N/dm to 5 N/dm.

In some embodiments, the peelable adhesive can provide a shear strength of, for example. 1-20 pounds per square inch as measured by ASTM Test Method D3654M-06.

Alternatively, the backplate may include a stretch release adhesive layer. A suitable stretch Releasing adhesive can comprise an elastic backing, or a highly extensible and substantially inelastic backing, with a pressure-sensitive adhesive disposed (e.g., coated) thereupon. Or the stretch-release adhesive can be formed of a solid, elastic pressure-sensitive adhesive. Thus, in this context, the term “stretch-release adhesive” encompasses products that comprise a unitary, integral, or solid construction of adhesive (in addition to products that comprise a backing with separate layers of adhesive residing thereupon). Suitable exemplary stretch-releasing adhesives are described in U.S. Pat. No. 4,024,312 to Korpman; German Patent No. 33 31 016; U.S. Pat. No. 5,516,581 to Kreckel et al.; and PCT International Publication No. WO 95/06691 to Bries et al., the teachings of each of which are incorporated herein by reference. Such stretch-release adhesives can range, for example, from about 0.2 mm in thickness to about 2 mm in thickness. If the storage assembly 200 is to be mounted in a moist environment, the composition of the stretch-releasing adhesive can be chosen so as to maintain appropriate adhesion in the presence of moisture. A suitable stretch-releasing adhesive is the double-sided stretch removable adhesive strips available from 3M Company. St. Paul, Minnesota under the COMMAND trade designation. Commercially available COMMAND adhesive strips are currently manufactured as discrete strips with one end of the strip including a non-adhesive pull tab to facilitate stretching of the strip during removal.

### Adhesive Article(s)

In some embodiments, the adhesive assembly further includes one or more release liners adjacent the adhesive layer(s) the mounting plate(s). The release liner can be, for example, on either or both of the major surfaces of the adhesive layers. The release liner protects the adhesive during manufacturing, transit, and before use. When the user desires to use the adhesive article, the user can peel or remove the release liner to expose the adhesive. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048, and incorporated herein. Preferred release liners are fluoroalkyl silicone polycoated paper. The release liners can be printed with lines, brand indicia, or other information.

In some embodiments, the mounting plates of the present disclosure can be removed from a substrate or surface without damage. In particularly advantageous embodiments, the adhesive articles can be removed from at least one of painted drywall and wallpaper without damage.

Some storage assemblies of the present disclosure have excellent shear strength. Some embodiments of the present disclosure have a shear strength of greater than 1600 minutes as measured according to ASTM D3654-82. Some embodiments of the present disclosure have shear strength of greater than 10,000 minutes as measured according to ASTM D3654-82. Some other embodiments of the present disclosure have shear strength of greater than 100,000 minutes as measured according to ASTM D3654-82.

Some mounting assemblies of the present disclosure demonstrate a lower peel adhesion to make the adhesive article easier to remove. Others demonstrate a higher peel adhesion, yet still provide for damage free removal. Some assemblies of the present disclosure can have a higher peel adhesion as to permit handling of the adhesive article by the user without accidental separation. Some embodiments of the present disclosure have a peel adhesion between about 5 oz/into 50 oz/in. Some embodiments of the present disclosure have a peel adhesion between about 10 oz/in to 40 oz/in. Some embodiments of the present disclosure have a peel adhesion between about 15 oz/in to 30 oz/in.

Some mounting assemblies of the present disclosure demonstrate improved weight bearing capacity, holding a 10 lbs weight for at least 72 hours. In presently preferred embodiments, the mounting assemblies of the present disclosure demonstrate improved weight bearing capacity, holding a 10 lbs weight for at least one week. In presently preferred embodiments, the adhesive articles of the present disclosure demonstrate improved weight bearing capacity, holding a 10 lbs weight for at least two weeks. The improved weight bearing capacity tends to allow for a greater variety of storage devices and greater storage capacities during use.

Some assemblies of the present disclosure include adhesive layers having a tensile strength at break sufficiently high so that the adhesive will not rupture prior to being removed from an adherend at an angle of 35° or greater. In some embodiments, the assemblies of the present disclosure include adhesive exhibiting an enhanced conformability to a substrate or surface than prior art adhesive mounting articles. In some embodiments, the assemblies of the present disclosure hold more weight when adhered or attached to a substrate or surface than prior art adhesive mounting articles. In some embodiments, the assemblies of the present disclosure hold more weight for a longer period of time when adhered or attached to a substrate or surface than prior art adhesive mounting articles. In some embodiments, the assemblies of the present disclosure remain adhered to a textured, rough, or irregular surface for a longer period of time than prior art adhesive mounting articles. In some embodiments, the assemblies of the present disclosure hold a higher amount of weight when adhered to a textured, rough, or irregular surface than prior art adhesive mounting articles.

Assemblies of the present disclosure can advantageously provide enhanced weight bearing capability with a reduction or elimination of substrate damage on removal. Accordingly, presently preferred embodiments of the present disclosure demonstrate effective weight bearing capacity, a stronger adhesion per square inch of available adhesive area, and peel-removability from a painted drywall substrate without damage. Moreover, at least one of the flexible body and adhesive layer can typically be reused after removal of the article from an adherend. Typically, the flexible body can be repurposed for use with a new adhesive layer, particularly if using stretch releasable adhesive strips. In other embodiments, the entire adhesive article is repositionable or reusable.

### Method of Making the Adhesive Articles Described Herein

The adhesive articles described herein can be made in various ways. One embodiment involves disposing an adhesive onto or adjacent to a major surface of a flexible body.

The adhesive can be disposed on the flexible body in any known way, including, for example, the pressure sensitive adhesive composition can be coated onto a release liner, coated directly onto a body, or formed as a separate layer (e.g., coated onto a release liner) and then laminated to a body. An adhesive can be deposited onto the flexible body with a known deposition method, including, e.g., solvent coating methods, water-borne coating methods, or hot melt coating methods, e.g., knife coating, roll coating, reverse roll coating, gravure coating, wire wound rod coating, slot orifice coating, slot die coating, extrusion coating, or the like.

### Methods of Using the Adhesive Articles Described Herein

The mounting assemblies of the present disclosure can be used in various ways. Where a release liner is present, the release liner is removed before the adhesive article is applied, attached to, or pressed into an adherend (e.g., tile wall surface). In some embodiments, at least a portion of the adherend is wiped with alcohol before the adhesive article is applied, attached to, or pressed into an adherend.

To remove the adhesive article from the adherend, at least a portion of the adhesive layer(s) is peeled or stretched away from the adherend. In some embodiments, the mounting plate and adhesive are removed together. In other embodiments, the mounting plate is removed first in order to access the adhesive layer. In such embodiments, the cover and storage device are typically dissembled before the adhesive layer is removed.

### Uses

The mounting assemblies may be used in wet or high humidity environments such as those found in bathrooms. For example, they can be adhered to toilets (e.g., toilet tanks), bathtubs, sinks, and walls. The adhesive article may be used in showers, locker rooms, steam rooms, pools, hot tubs, and kitchens (e.g., kitchen sinks, dishwashers and back splash areas, refrigerators and coolers). The adhesive article may also be used in low temperatures applications including outdoor applications and refrigerators. Useful outdoor applications include bonding articles such as signage to outdoor surfaces such as windows, doors and vehicles.

The mounting assemblies may be used to mount various items and objects to surfaces such as painted drywall, plaster, concrete, glass, ceramic, fiberglass, metal or plastic. Items that can be mounted include, but are not limited to, the storage devices depicted herein, other wall hangings, organizers, holders, baskets, containers, decorations (e.g., holiday decorations), calendars, posters, dispensers, wire clips, body side molding on vehicles, carrying handles, signage applications such as road signs, vehicle markings, transportation markings, and reflective sheeting.

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

1. A mountable apparatus comprising:
a storage device including at least one wire segment;
at least one mounting plate onto which at least one of the wire segments is engaged; and
optionally a cover attachable to the wire structure, the cover obscuring the at least one hanger and at least a portion of at least one of the wire segments.

2. The mountable apparatus of claim 1, wherein the storage device includes at least two substantially parallel wire segments.

3. (canceled)

4. (canceled)

5. The mountable apparatus of claim 1, wherein the flexible body is more rigid in a longitudinal direction than a transverse direction.

6. The mountable apparatus of claim 1, wherein the flexible mounting body includes a plurality of discrete body segments arranged at a defined pitch.

7. The mountable apparatus of claim 2, wherein the mounting plate includes a least two flexible mounting bodies arranged in parallel.

8. (canceled)

9. The mountable apparatus of claim 1, wherein the flexible mounting body includes a recess dimensioned to receive a wire segment of the wire structure.

10. The mountable apparatus of claim 9, wherein each flexible mounting body includes a recess having a bottom surface, and wherein the bottom surfaces of each recess are substantially coplanar.

11. The mountable apparatus of claim 1, wherein the cover contains at least one tenon to snap on the wire structure, and wherein the cover includes a retention notch on left and right side of said cover to engage and hold the wire segment.

12. (canceled)

13. The mounting apparatus of claim 1, wherein the backplate comprises at least one polymeric film layer.

14. The mountable apparatus of claim 1, wherein the backplate comprises a foam layer.

15. The mountable apparatus of claim 14, wherein the foam layer is adhered directly to the polymeric film layer or through the use of a tie layer.

16. The mountable apparatus of claim 1, wherein the backplate comprises a peelable silicone adhesive on a second major surface thereof opposing the hanger.

17. The mountable apparatus of claim 16, wherein the peelable silicone adhesive is disposed on a surface of the foam layer opposite the polymeric film layer.

18. The mountable apparatus of claim 1, wherein the cover has an awning, the awning obscuring the at least one hanger and at least a portion of the each of the wire segments.

19. A mounting plate for use in hanging items, the mounting plate comprising:
a solid backplate having a longitudinal length and latitudinal width; and
a plurality of fins on a first major surface of the backplate, wherein the fins extend at least a portion of the length and are spaced from one another along the width, and wherein at least some of the fins include a hook portion projecting from a front surface of the fin and defining a recess.

20. The mounting plate of claim 19, and further comprising at least two adhesive strips on a second major surface of the backplate.

21. The mounting plate of claim 20, wherein each strip is stretch releasable.

22. The mounting plate of claim 19, wherein the fins include a height from the backplate that tapers adjacent a top edge of the backplate.

23. The mounting plate of claim 19 and comprising at least six fins.

24. The mounting plate of claim 23, wherein the at least six fins includes a first group of three fins and a second group of three fins, wherein the first group and second group are separated by a first pitch, and wherein each fin within the first group or second group is separated by a second pitch, and wherein the first pitch is greater than the second pitch.
